(19) United States
(12) Patent Application Publication
(10) Pub. No.: US 2025/0300232 A1
(43) Pub. Date: Sep. 25, 2025

(54) FLUORINATED ACETAL ELECTROLYTES FOR HIGH-VOLTAGE AND LOW-IMPEDANCE LITHIUM METAL BATTERIES

(71) Applicant: The Board of Trustees of the Leland Stanford Junior University, Stanford, CA (US)

(72) Inventors: Yuelang CHEN, Stanford, CA (US); Zhiao YU, Mountain View, CA (US); Zhenan BAO, Stanford, CA (US); Yi CUI, Stanford, CA (US)

(73) Assignee: The Board of Trustees of the Leland Stanford Junior University, Stanford, CA (US)

(21) Appl. No.: 18/863,325

(22) PCT Filed: May 5, 2023
(86) PCT No.: PCT/US2023/021234

§ 371 Date: Nov. 5, 2024

Related U.S. Application Data
(60) Provisional application No. 63/339,300, filed on May 6, 2022.

(51) Int. Cl. H01M 10/0569; H01M 4/02; H01M 4/38; H01M 10/0525; H01M 10/0568; H01M 50/609

(52) U.S. Cl. CPC H01M 10/0569; H01M 4/382; H01M 10/0525; H01M 10/0568; H01M 50/609; H01M 2004/027; H01M 2300/0034; H01M 2300/0037

(57) ABSTRACT

The present embodiments relate generally to electrolytes for energy storage devices and more particularly to a family of fluorinated acetal molecules as the solvent component for the electrolytes. The present embodiments are directed to electrolytes comprising one or more fluorinated acetal molecules as solvents, and one or more salts, wherein the salts are soluble in the solvents. The electrolytes can be formulated with or without any additional solvents, diluents, or additives. The fluorinated acetal molecules comprise molecular formula of R1-O-CH2-O-R2, wherein R1 and R2 are hydrocarbon, fluorocarbon, or hydrofluorocarbon chains. The products of some embodiments include di(2-fluoroethoxy)methane (F1DEM) and bis(2,2-difluoroethoxy)methane (F2DEM). The obtained electrolytes enable high Coulombic efficiency, quick stabilization of electrodes, good compatibility with high-voltage cathodes, fast ion transport, and low overpotential.

### CROSS-REFERENCE TO RELATED APPLICATIONS

The present application claims priority to U.S. Provisional Patent Application No. 63/339,300 filed May 6, 2022. The present application is also related to PCT Application No. US20/048423, filed Aug. 28, 2020, U.S. Provisional Patent Application No. 63/270,506 filed Oct. 21, 2021 and U.S. Provisional Patent Application No. 63/283,828 filed Nov. 29, 2021, the contents of all such applications being incorporated herein by reference in their entirety.

### STATEMENT OF GOVERNMENT SPONSORED RESEARCH

This invention was made with Government support under contract number DE-AC02-76SF00515 awarded by the Department of Energy. The Government has certain rights in the invention.

### TECHNICAL FIELD

The present embodiments relate generally to electrolytes for energy storage devices, and more particularly to a family of fluorinated acetal molecules as the solvent component for the electrolytes.

### BACKGROUND

Previous patent applications by the present Applicant on fluorinated dimethoxybutane (FDMB, PCT Application No. US20/048423), fluorinated diethoxyethane (FDEE, PCT Application No. US22/47472), and nonfluorinated ethylene glycols and acetals (PCT Application No. US22/47472), the contents of which are incorporated herein by reference, dramatically advanced electrolyte's compatibility with lithium metal batteries. Nevertheless, certain opportunities for improvement remain.

### SUMMARY

The present embodiments relate generally to electrolytes for energy storage devices and more particularly to a family of fluorinated acetal molecules as the solvent component for the electrolytes. The present embodiments are directed to electrolytes comprising one or more fluorinated acetal molecules as solvents, and one or more salts, wherein the salts are soluble in the solvents. The electrolytes can be formulated with or without any additional solvents, diluents, or additives. The fluorinated acetal molecules comprise molecular formula of R1-O-CH2-O-R2, wherein R1 and R2 are hydrocarbon, fluorocarbon, or hydrofluorocarbon chains. The products of some embodiments include di(2-fluoroethoxy)methane (F1DEM) and bis(2,2-difluoroethoxy)methane (F2DEM). The obtained electrolytes enable high Coulombic efficiency, quick stabilization of electrodes, good compatibility with high-voltage cathodes, fast ion transport, and low overpotential.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates example reaction schemes according to embodiments.

FIG. 2 illustrates Proton NMR results of an example F1DEM according to embodiments.

FIG. 3 illustrates F19 NMR results of an example F1DEM according to embodiments.

FIG. 4 illustrates proton NMR results of an example F2DEM according to embodiments.

FIG. 5 illustrates F19 NMR results of an example F2DEM according to embodiments.

FIG. 6 is a graph illustrating ionic conductivities of LiFSI in example F1DEM electrolytes according to embodiments at various salt concentrations.

FIG. 7 is a graph illustrating apparent ionic conductivities of LiFSI in example F1DEM electrolytes according to embodiments at various salt concentrations soaked in Celgard 2325 separator.

FIG. 8 is a graph illustrating Coulombic efficiency measurement of 2 M LiFSI/F1DEM according to embodiments based on Aurbach method.

FIG. 9 is a graph illustrating voltage profiles for varying current densities in Li∥Li symmetric cells using 2 M LiFSI/F1DEM according to embodiments and 1.2 M LiFSI/F5DEE.

FIG. 10 is a graph illustrating overpotential in Li∥Cu cells with 1.2 M LiFSI/F1DEM (0.5 mA cm⁻², 1 mAh cm⁻²) according to embodiments compared with other other advanced electrolytes.

FIG. 11 is a graph illustrating overpotential in Li∥Cu cells with 2 M LiFSI/F1DEM (0.5 mA cm⁻², 1 mAh cm⁻²) according to embodiments compared to other advanced electrolytes.

FIGS. 12A and 12B are graphs illustrating discharge capacity and CE, respectively, of anode-free LFP pouch cells using 2 M LiFSI/F1DEM (labeled F1DEM) according to embodiments and 1.2 M LiFSI/F5DEE (labeled F5DEE) under C/2 charge and C/5 discharge.

FIGS. 13A and 13B are graphs illustrating discharge capacity and CE, respectively, of anode-free LFP pouch cells using 2 M LiFSI/F1DEM (labeled F1DEM) according to embodiments, 1.2 M LiFSI/F4DEE (labeled F4DEE), and 1.2 M LiFSI/F5DEE (labeled F5DEE) under C/2 charge and 2C discharge.

FIGS. 14A and 14B are graphs illustrating discharge capacity and CE, respectively, of anode-free LFP pouch cells using 2 M LiFSI/F1DEM (labeled F1DEM) according to embodiments, 1.2 M LiFSI/F4DEE (labeled F4DEE), and 1.2 M LiFSI/F5DEE (labeled F5DEE) under C/2 charge and C/2 discharge.

FIGS. 15A and 15B are graphs illustrating discharge capacity and CE, respectively, of Li∥LFP coin cells with 20-μm-thick Li anode and high-loading LFP cathode using 2 M LiFSI/F1DEM according to embodiments under various charge and discharge current densities.

FIGS. 16A and 16B are graphs illustrating LSV of Li∥Pt cells having electrolytes that contain 2 M LiFSI in various volume ratios of F1DEM:F2DEM according to embodiments.

FIGS. 17A, 17B, 17C and 17D are graphs illustrating long-term CE of Li∥Cu cells at 0.5 mA cm⁻² and 1 mAh cm⁻² using 2 M LiFSI in various volume ratios of F1DEM:F2DEM according to embodiments.

FIG. 18 is a graph illustrating ionic conductivities of 2 M LiFSI in various volume ratios of F1DEM:F2DEM according to embodiments in Celgard 2325.

FIGS. 19A and 19B are graphs illustrating discharge capacity and CE, respectively, of Li∥NMC811 coin cells with 50-μm-thick Li anode and high-loading NMC811 cathode using 2 M LiFSI in 1:1 or 2:1 volume ratio of F1DEM:F2DEM according to embodiments.

FIGS. 20A and 20B are graphs illustrating discharge capacity and CE, respectively, of Li∥NMC811 coin cells with 50-μm-thick Li anode and high-loading NMC811 cathode using 2 M LiFSI in 1:1 or 2:1 volume ratio of F1DEM:F2DEM according to embodiments.

FIG. 21A is a diagram illustrating an example battery according to embodiments.

FIG. 21B is a flowchart illustrating an example methodology for obtaining an electrolyte for a battery according to embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claim to be ascribed an uncommon or special meaning unless explicitly set forth as such. Further, the present embodiments encompass present and future known equivalents to the known components referred to herein by way of illustration.

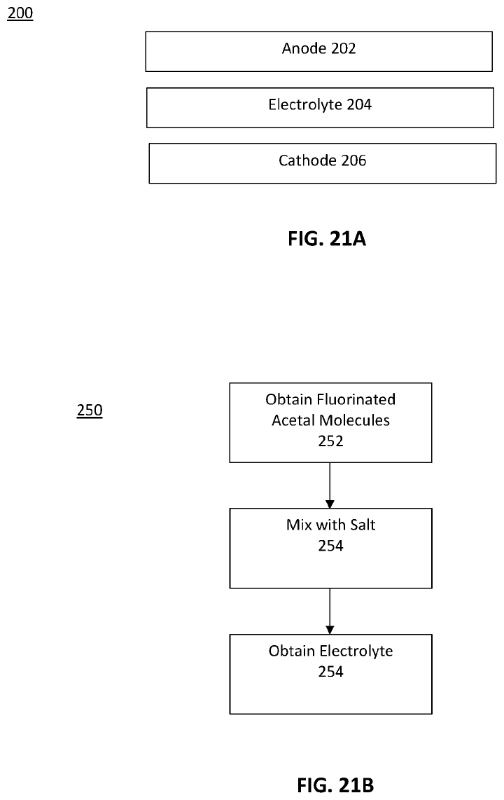

As lithium ion batteries quickly approach their theoretical limit, new chemistry is required to further improve energy density of batteries. One promising approach is to replace the graphite anode (e.g. 202 in battery 200 shown in FIG. 21A) with pure lithium metal, which increases anode specific capacity by about 10 times. However, common lithium ion battery electrolytes (e.g. 204 in battery 200) are incompatible with a lithium metal anode (e.g. 202 in battery 200). In recent years, many new electrolytes have been developed to improve lithium Coulombic efficiency to above 99%. However, there are several issues. (1) Most of these electrolytes show low initial Coulombic efficiencies. It usually takes tens of cycles to reach 99%. (2) Virtually all of these electrolytes show slow ion transport properties, which results in high cell impedance that renders the batteries unsuitable for many applications such as EV. (3) Some of these electrolytes are incompatible with high-voltage cathodes (e.g. 206 in battery 200). For example, in some applications, anything above 4V can be considered high voltage cathode. Some example cathodes in such applications include lithium nickel manganese cobalt oxides (NMC) family, lithium cobalt oxides (LCO), lithium nickel manganese oxides (LNMO). (4) Many of these electrolytes use exotic salts or solvents that are expensive to manufacture even at scale.

According to some aspects, embodiments provide new organic molecules that can simultaneously address all four issues above.

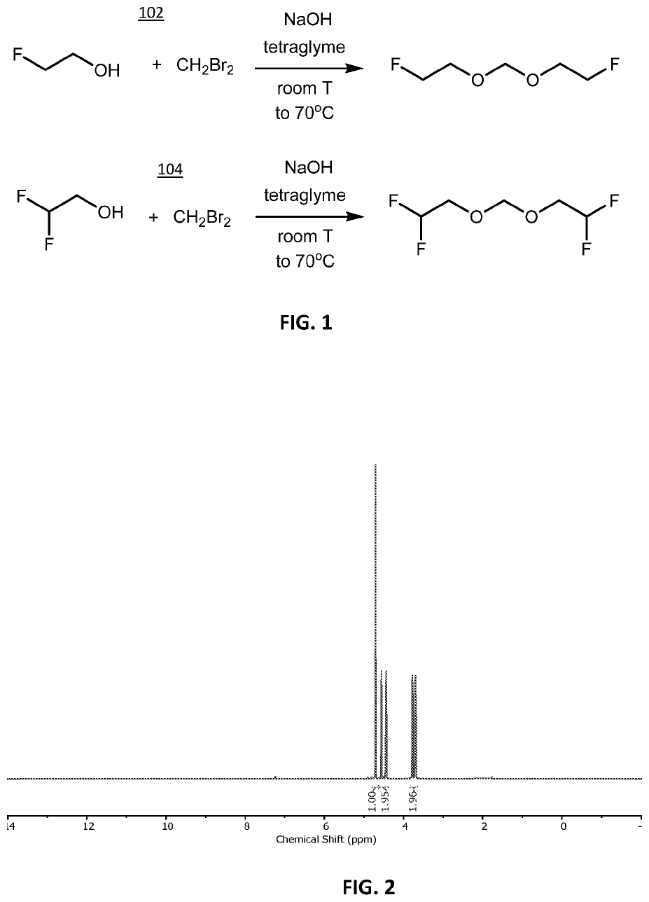

The present Applicants designed and synthesized two new organic molecules: di-(2-fluoroethoxy)methane (F1DEM) and bis-(2,2-difluoroethoxy)methane (F2DEM). Both molecules can be obtained by facile reactions from common chemical feedstocks at high yields, for example using the reactions 102, 104 respectively shown in FIG. 1. When paired with standard LiFSI salt at low to moderate concentrations as described below, the resulting electrolytes (e.g. for use as 204 in battery 200 shown in FIG. 21A) demonstrate fast stabilization of lithium metal, good compatibility with high-voltage cathodes (e.g. 206 in battery 200, FIG. 21A), fast ion transport, and low cell impedance.

One aspect of embodiments is that the —O—C—O— backbone in diethoxymethane (DEM) possesses weaker solvation ability compared to the —O—C—C—O— chelating backbone in 1,2-diethoxyethane (DEE), providing better electrode stability. DEM has lower viscosity than DEE, providing higher ionic conductivity at the same salt concentration. The molecular properties are fine-tuned by the degree of fluorination on the end substituents, including —CHF2 group and —CH2F group.

In any event, these new solvent molecules can be used for electrolyte formulation for lithium metal batteries. Likely customers include existing cell makers and battery startups. Compared to the existing advanced electrolytes for lithium metal batteries, these new solvents enable the formulation of electrolytes that (1) are faster to stabilize lithium metal cycling, (2) offer similar or better compatibility with existing cathodes, (3) enable lower cell impedance, and (4) are more scalable and economically viable.

### Example Materials and Synthesis

As shown schematically in FIG. 1, in some embodiments, to a 500 mL round flask was added 64 g of 2-fluoroethanol, 85 g of dibromomethane, 43 g of NaOH and 200 mL tetraglyme. The suspension was stirred at room temperature for 2 h and then heated to 40° C. to stir overnight. The suspension turned brownish with yellow fine powder. The suspension was further heated to 70° C. to stir overnight. The suspension was directly distilled under vacuum (vapor temperature ˜70-75° C. at ˜1 kPa) to obtain colorless liquid as the product. The crude product (e.g. F1DEM for process 102 in FIG. 1) was distilled under vacuum for four times to ensure purity. In alternate embodiments, for obtaining F2DEM (e.g. in accordance with process 104), about 82 g of 2,2-Difluoroethanol is used instead of 2-fluoroethanol.

In one example of materials used in the flow described above, 2-Fluoroethanol was obtained from Matrix Scientific, 2,2-Difluoroethanol was obtained from SynQuest and NaOH, tetraglyme, dibromomethane and other general reagents were purchased from Sigma or Fisher. In these and other examples, the molar ratio between 2-fluoroethanol and dibromomethane is preferably higher than 2. The molar ratio between 2,2-difluoroethanol and dibromomethane is preferably higher than 2. The molar ratio between NaOH and 2-fluoroethanol is preferably higher than 1. The molar ratio between NaOH and 2,2-difluoroethanol is preferably higher than 1. It should be noted that dibromomethane can be substituted by other dihalomethane, such as dichloromethane and diiodomethane. Dibromomethane can be substituted by formaldehyde or paraformaldehyde.

FIGS. 2 and 4 are graphs illustrating Proton NMR results of example F1DEM and F2DEM products, respectively, produced according to the methodology described above according to embodiments. In the graphs shown in these figures, (chemical shift in ppm is on the x-axis and the y-axis illustrates corresponding signal intensity at the respective values of chemical shift).

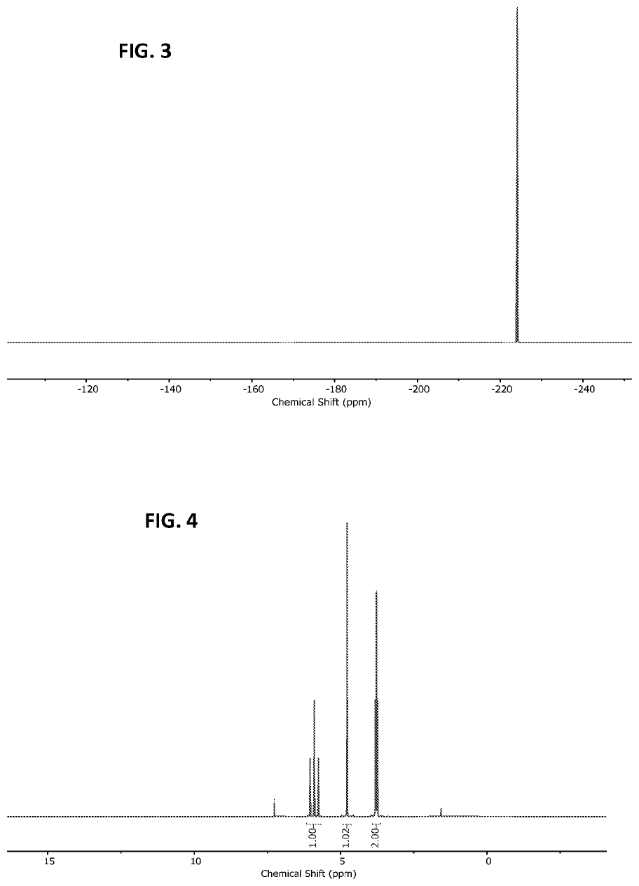

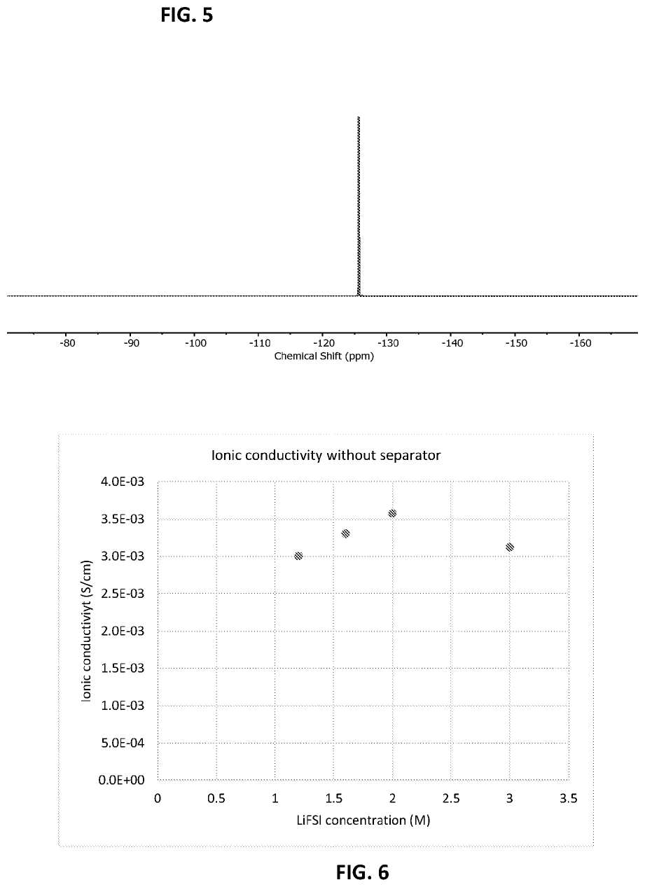

FIGS. 3 and 5 are graphs illustrating F19 NMR results of example F1DEM and F2DEM products, respectively, produced according to the methodology described above according to embodiments. In the graphs shown in these figures, (chemical shift in ppm is on the x-axis and the y-axis illustrates corresponding signal intensity at the respective values of chemical shift).

### Ionic Conductivity

Referring to FIG. 21B, according to certain aspects, a general methodology 250 of fabricating an electrolyte for use in a Lithium battery includes a first operation 252 of obtaining fluorinated acetal molecules. The fluorinated acetal molecules are comprised of the formula R1-O-CH2-O-R2, wherein R1 and R2 are hydrocarbon, fluorocarbon, or hydrofluorocarbon chains. In embodiments, this operation 252 can include obtaining molecules of the F1DEM and F2DEM products using the steps described above, for example. In these and other embodiments, operation 252 can include a chemical reaction among one or more fluorinated alcohols, one or more bases, and a dihalomethane. Additionally or alternatively, operation 252 can include a chemical reaction among one or more fluorinated alcohols, formaldehyde, and one or more acids or bases. Still further, operation 252 can include a chemical reaction among one or more fluorinated alcohols, paraformaldehyde, and one or more acids or bases.

In a next operation 254, a salt is dissolved in the obtained fluorinated acetal molecules. The salt can be LiFSI, however embodiments are not limited to salts including Li, and can include alkali metal ion salts based on lithium, sodium, or potassium, and/or fluorinated sulfonimide salts, fluorinated phosphate salts, or fluorinated boron salts. For example, in some embodiments, LiFSI is mixed with the F1DEM product obtained in 252 at 1.2 to 3 M concentrations. It should be noted that operation 254 can include mixing in other components as well, including additives, co-solvents, or diluents

In any event, an electrolyte is obtained from this mixture in operation 256. The intrinsic ionic conductivities of the obtained electrolyte peak at around 2 M. When injected into Celgard 2325 separator, 2 M remains to be a preferred concentration for high ionic conductivity.

FIG. 6 is a graph illustrating Ionic conductivities of LiFSI in example F1DEM electrolytes (without separator) according to embodiments at various salt concentrations between about 1.2 to 3M. FIG. 7 is a graph illustrating apparent ionic conductivities of LiFSI in example F1DEM electrolytes soaked in Celgard 2325 separator according to embodiments at various salt concentrations between about 1.2 to 3M.

Lithium metal Coulombic efficiency:

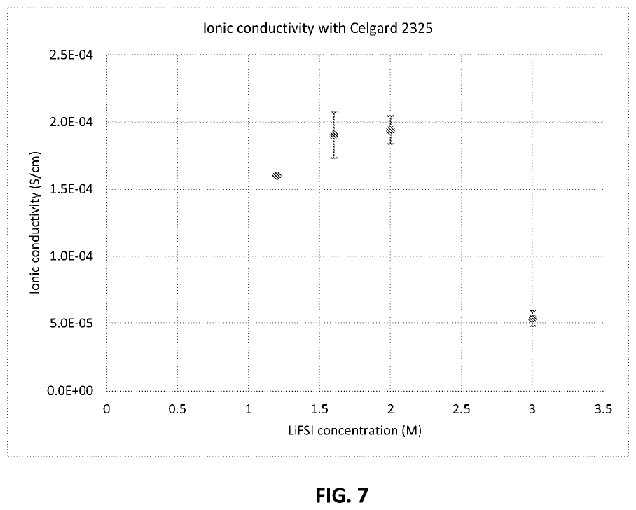

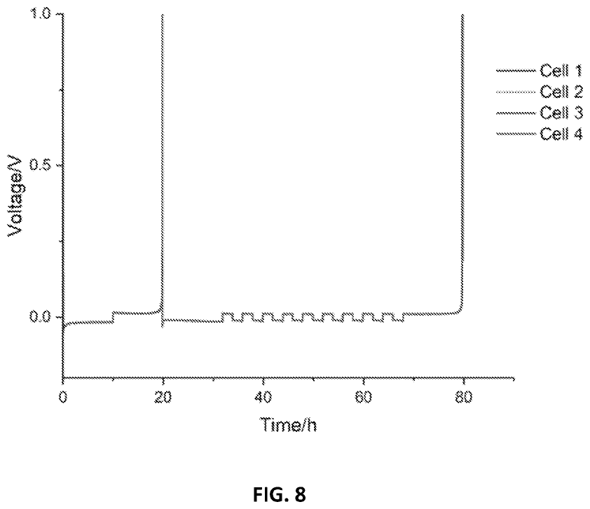

The average Coulombic efficiency (CE) of 2 M LiFSI/F1DEM as an electrolyte according to embodiments, obtained as described above for example, can be evaluated by Aurbach method in Li—Cu half cells. Based on this standard protocol, 5 mAh cm⁻² of Li is first deposited onto the Cu foil as Li reservoir. This is followed by 10 subsequent cycles of plating and stripping at 0.5 mA cm⁻² for 1 mAh cm⁻². Finally, all deposited Li is stripped from Cu, and the total capacity recovered is divided by the amount deposited to obtain the CE. The average CE of four cells calculated based on this method is 99.5%, which is comparable to the 99.5% CE previously observed with F5DEE (PCT Application No. US22/47472). FIG. 8 is a graph illustrating example results for a Coulombic efficiency measurement of 2 M LiFSI/F1DEM based on Aurbach method as described above. Although results for four replicated cells are shown, the results are substantially similar and visually indistinguishable in the graph.

### Overpotential

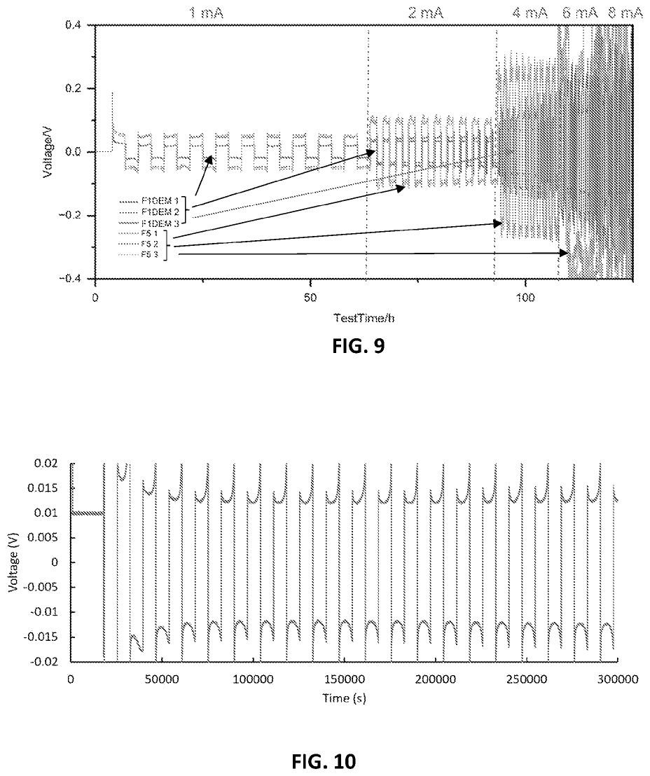

Li∥Li symmetric cell cycling at a capacity of 3 mAh cm⁻² was investigated. To assess the fast-charging capability, current density is gradually increased over test time from 1 mA cm⁻² to 8 mA cm⁻², with 10 cycles at each current density. FIG. 9 is a graph illustrating voltage profiles for varying current densities in Li∥Li symmetric cells using 2 M LiFSI/F1DEM (F1DEM 1, 2 and 3 as shown in FIG. 9) according to embodiments as an electrolyte and 1.2 M LiFSI/F5DEE (FS 1, 2 and 3 as shown in FIG. 9) as an electrolyte. The electrode area is 1 cm². The capacity is 3 mAh. The current is 1, 2, 4, 6, 8 mA as labeled on top of the graph. As can be seen from FIG. 9, the overpotential of 2 M LiFSI/F1DEM is roughly 50% less than that of 1.2 M LiFSI/F5DEE under all current densities.

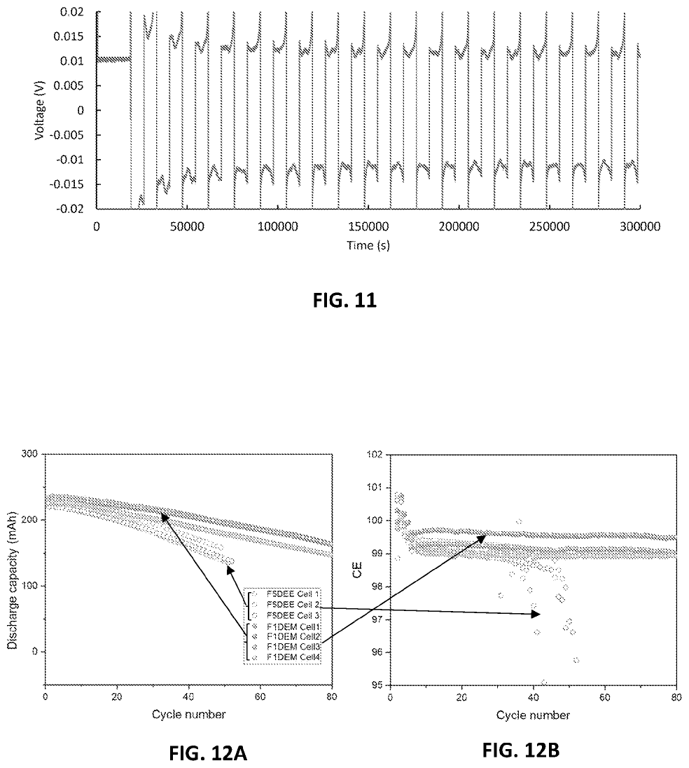

The overpotential in Li∥Cu cells can also be evaluated at 0.5 mA cm⁻² and 1 mAh cm⁻². For example, FIG. 10 is a graph illustrating overpotential in Li∥Cu cells with 1.2 M LiFSI/F1DEM (0.5 mA cm⁻², 1 mAh cm⁻²) according to embodiments as an electrolyte and FIG. 11 is a graph illustrating overpotential in Li∥Cu cells with 2 M LiFSI/F1DEM (0.5 mA cm⁻², 1 mAh cm⁻²) according to embodiments as an electrolyte. The overpotentials of other advanced electrolytes under the same condition are shown for comparison in FIGS. 10 and 11.

As can be seen from FIGS. 10 and 11, electrolytes according to embodiments using 1.2 M LiFSI/F1DEM and 2 M LiFSI/F1DEM show overpotentials of around 12 mV and 11 mV respectively, which are lower than most of the reported advanced electrolytes for lithium metal batteries. It should be noted that the lower overpotential of 2 M LiFSI/F1DEM will lead to a higher energy efficiency.

### Anode-Free Cu∥LFP Pouch Cell Performance

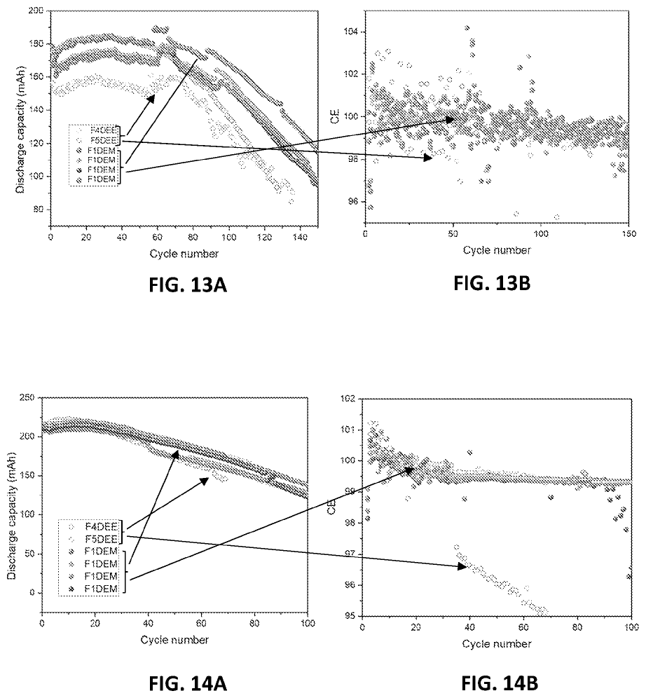

The performance of 2 M LiFSI/F1DEM as an electrolyte can be further assessed in Cu∥LFP anode-free pouch cells, with a voltage range from 2.5 V to 3.65 V. For example, an electrolyte comprising 2 M LiFSI/F1DEM is compared to an electrolyte comprising 1.2 M LiFSI/F5DEE under different charging and discharging rates (1C=200 mA or 2 mA cm⁻²). More particularly, FIG. 12A is a graph illustrating discharge capacity and FIG. 12B is a graph illustrating CE, respectively, of anode-free LFP pouch cells using an example 2 M LiFSI/F1DEM (labeled F1DEM) according to embodiments and 1.2 M LiFSI/F5DEE (labeled F5DEE) under C/2 charge and C/5 discharge. FIG. 13A is a graph illustrating discharge capacity and FIG. 13B is a graph illustrating CE, respectively, of anode-free LFP pouch cells using 2 M LiFSI/F1DEM (labeled F1DEM) according to embodiments as an electrolyte, 1.2 M LiFSI/F4DEE (labeled F4DEE) as an electrolyte, and 1.2 M LiFSI/F5DEE (labeled F5DEE) as an electrolyte under C/2 charge and 2C discharge. FIG. 14A is a graph illustrating discharge capacity and FIG. 14B is a graph illustrating CE, respectively, of anode-free LFP pouch cells using 2 M LiFSI/F1DEM (labeled F1DEM) according to embodiments as an electrolyte, 1.2 M LiFSI/F4DEE (labeled F4DEE) as an electrolyte, and 1.2 M LiFSI/F5DEE (labeled F5DEE) as an electrolyte under C/2 charge and C/2 discharge.

As can be seen from the above FIGS. 12A and 12B, with C/2 charge and C/5 discharge, significant improvement in discharge capacity and CE is observed in 2 M LiFSI/F1DEM according to embodiments compared to 1.2 M LiFSI/F5DEE. Likewise as shown in FIGS. 13A and 13B, with C/2 charge rate and a faster 2C discharge rate, 2 M LiFSI/F1DEM according to embodiments shows higher capacity utilization and slower capacity loss than 1.2 M LiFSI/F5DEE. Still further as shown in FIGS. 14A and 14B, under C/2 charge rate and C/2 discharge rate, 2 M LiFSI/F1DEM according to embodiments, yields similar cycling performance as 1.2 M LiFSI/F5DEE, although it greatly surpasses 1.2 M LiFSI/F4DEE. Overall, 2 M LiFSI/F1DEM according to embodiments shows excellent performance in the anode-free LFP pouch cells under all tested rates.

### Li∥LFP Coin Cell Performance

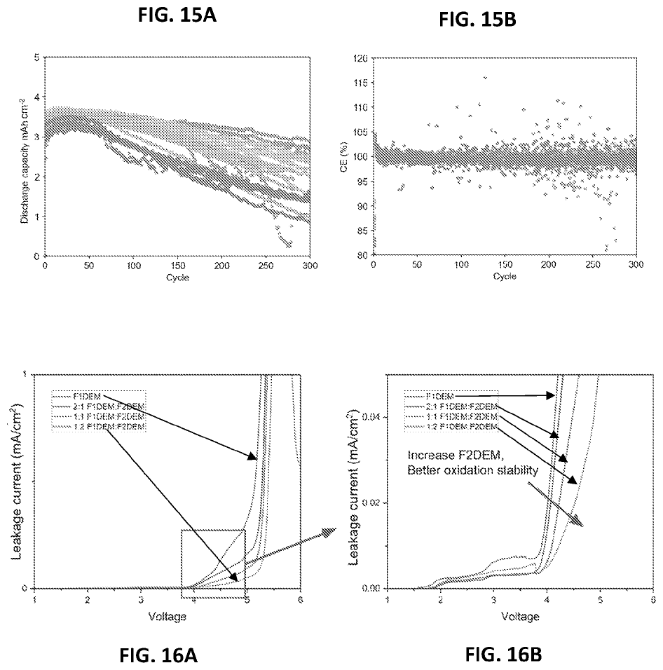

The cycling performance of 2 M LiFSI/F1DEM according to embodiments is also evaluated in Li∥LFP coin cells with 20-μm-thick Li anode and high-loading LFP cathode. For example, FIG. 15A is a graph illustrating discharge capacity and FIG. 15B is a graph illustrating CE, respectively, of Li∥LFP coin cells with 20-μm-thick Li anode and high-loading LFP cathode using 2 M LiFSI/F1DEM as an electrolyte under various charge and discharge current densities. Various charge and discharge current densities (0.4 mA cm⁻² charge and 2 mA cm⁻² discharge, 0.75 mA cm⁻² charge and 1.5 mA cm⁻² discharge, 1 mA cm⁻² charge and 2 mA cm⁻² discharge, 1.5 mA cm⁻² charge and 3 mA cm⁻² discharge) are applied with results shown in

FIGS. 15A and 15B. Overall, it can be seen from FIGS. 15A and 15B that 2 M LiFSI/F1DEM exhibits excellent cycling stability.

### Improve Oxidation Stability by Mixing F1DEM and F2DEM

F2DEM is designed to further enhance the oxidative stability to improve the cycling performance in high-voltage lithium batteries. Linear sweep voltammetry (LSV) is performed in Li∥Pt cells with various F1DEM:F2DEM volume ratios. For example, FIGS. 16A and 16B are graphs illustrating LSV of Li∥Pt cells with pure 2 M LiFSI F1DEM, as compared with cells with 2:1 F1DEM to F2DEM volume ratios, cells with 1:1 F1DEM to F2DEM volume ratios and cells with 1:2 F1DEM to F2DEM volume ratios. FIG. 16A clearly illustrates increased oxidative stability with higher F2DEM volume ratio. FIG. 16B further illustrates the onset of a sharp increase in leakage current shifts to higher voltage as the F2DEM content increases. Therefore, by mixing F2DEM with F1DEM, the oxidation stability of electrolytes is improved.

### Improve CE by Mixing F1DEM and F2DEM

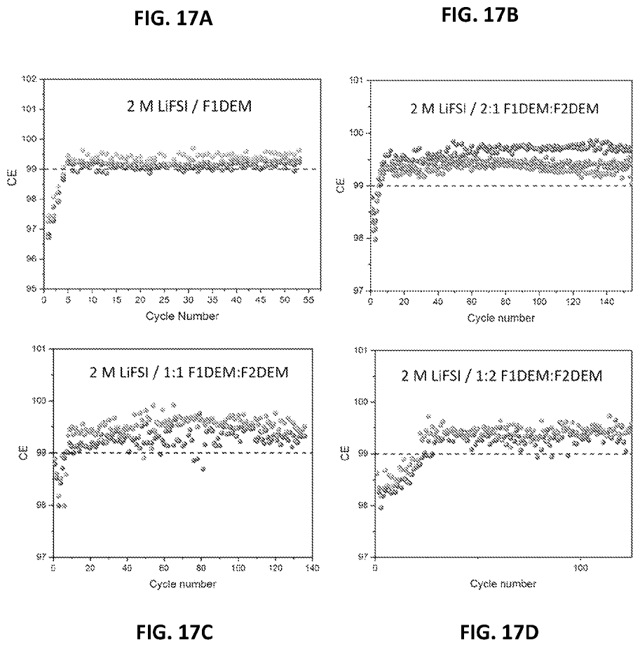

Evaluated was the long-term CE of Li∥Cu cells at 0.5 mA cm⁻² and 1 mAh cm⁻² using 2 M LiFSI in various volume ratios of F1DEM:F2DEM (0 F2DEM in FIG. 17A, 2:1 F1DEM:F2DEM in FIG. 17B, 1:1 F1DEM:F2DEM in FIG. 17C, and 1:2 F1DEM:F2DEM in FIG. 17D).

As can be seen in these figures, both 2:1 and 1:1 F1DEM:F2DEM show improved CE compared to F1DEM. In addition, they all demonstrate fast CE activation to >99%, which is highly desirable due to lower capacity loss during the first few cycles. However, if the F2DEM content is further increased to 1:2 F1DEM:F2DEM, the CE decreases slightly and the CE activation process is longer.

### Ionic Conductivity

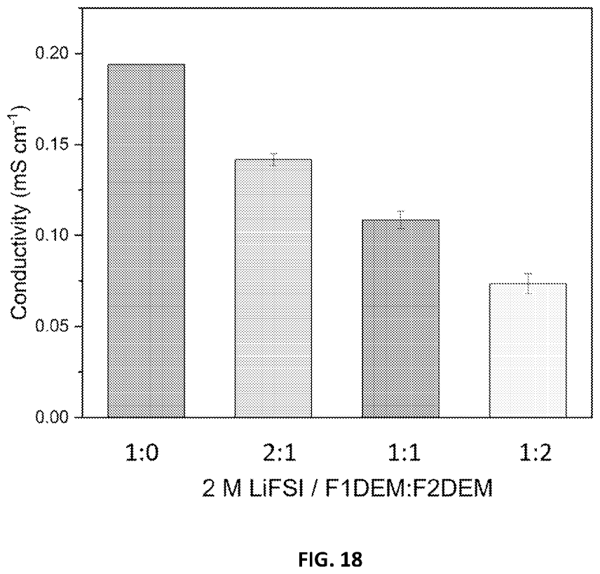

The ionic conductivities of 2 M LiFSI in various volume ratios of F1DEM:F2DEM were also measured in the presence of Celgard 2325 separator. For example, FIG. 18 is a graph illustrating ionic conductivities (y-axis) of 2 M LiFSI in various volume ratios of F1DEM:F2DEM in Celgard 2325 (x-axis). As can be seen from FIG. 18, increasing F2DEM content leads to a decrease in conductivity. Therefore, a balance between stability and ion transport must be considered in electrolyte formulation.

### Li∥NMC811 Coin Cell Performance

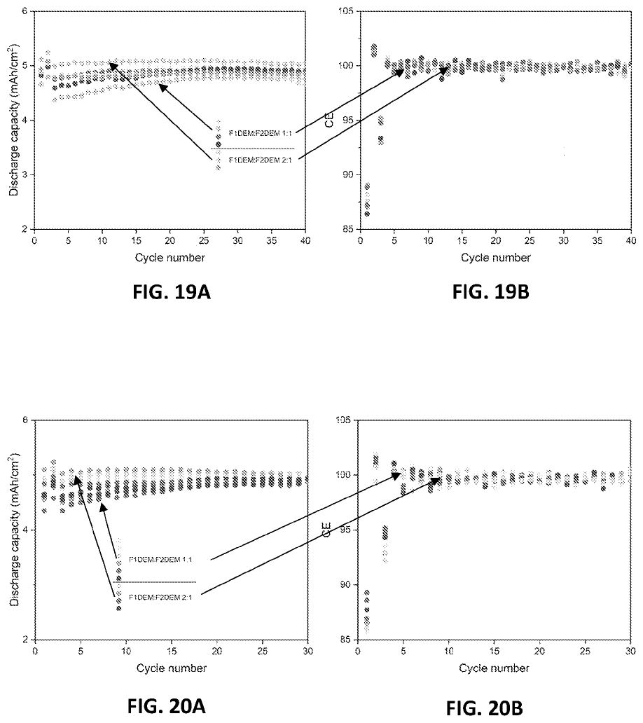

The cycling performance of 2 M LiFSI/1:1 and 2:1 F1DEM:F2DEM was evaluated in Li∥NMC811 coin cells with 50-μm-thick Li anode and high-loading NMC811 cathode. Various charge and discharge current densities (0.8 mA cm⁻² charge and 1.3 mA cm⁻² discharge, 0.4 mA cm⁻² charge and 1.3 mA cm⁻² discharge) were applied as shown in FIGS. 19 and 20.

More particularly, FIG. 19A is a graph illustrating discharge capacity and FIG. 19B is a graph illustrating CE, respectively, of Li∥NMC811 coin cells with 50-μm-thick Li anode and high-loading NMC811 cathode using 2 M LiFSI in 1:1 or 2:1 volume ratio of F1DEM:F2DEM. The cells were cycled between 2.8 and 4.4 V at 0.8 mA cm⁻² charge and 1.3 mA cm⁻² discharge current densities.

Similarly, FIG. 20A is a graph illustrating discharge capacity and FIG. 20B is a graph illustrating CE, respectively, of Li∥NMC811 coin cells with 50-μm-thick Li anode and high-loading NMC811 cathode using 2 M LiFSI in 1:1 or 2:1 volume ratio of F1DEM:F2DEM. The cells were cycled between 2.8 and 4.4 V at 0.4 mA cm⁻² charge and 1.3 mA cm⁻² discharge current densities.

FIGS. 19 and 20 generally illustrate that the electrolyte blend with F1DEM and F2DEM enables stable operation of high-voltage Li∥NMC811 batteries.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

1. A fluorinated acetal molecule, comprising the formula:
R1-O-CH2-O-R2, wherein:
R1 and R2 are hydrocarbons of a first formula —CₓH_{y}, fluorocarbons of a second formula —CₓF_{y}, or hydrofluorocarbons of a third formula —CₓH_{y}F_{z}, wherein x is 1-4, and y and z are any numbers required to complete the first, second and third formulas.

2. An electrolyte material, consisting essentially of:
one or more salts; and
one or more solvents comprising the fluorinated acetal molecule of claim 1, wherein the one or more salts are soluble in the one or more solvents.

3. The electrolyte material of claim 2, wherein the one or more salts comprise alkali metal ion salts including lithium, sodium, or potassium based salts.

4. The electrolyte material of claim 2, wherein the one or more salts comprise fluorinated sulfonimide salts, fluorinated phosphate salts, or fluorinated boron salts.

5. The electrolyte material of claim 2, wherein the one or more salts comprise metal ion salts.

6. The electrolyte material of claim 2, further comprising one or more additives.

7. The electrolyte material of claim 2, further comprising one or more diluents, wherein the solubility of one or more salts in the one or more diluents is less than 1% by mole.

8. The electrolyte materials of claim 2, further comprising one or more co-solvents, wherein the solubility of one or more salts in the one or more co-solvents is greater than 1% by mole.

9. The electrolyte material of claim 2, wherein the salt solubility is greater than 1% by mole.

10. The electrolyte material of claim 2, wherein the material is configured for lithium metal batteries, anode-free batteries, or lithium ion batteries.

11. The electrolyte material of claim 2, wherein the material is configured for metal batteries, or metal ion batteries.

12. The electrolyte material of claim 11, wherein the batteries include positive electrode chemistry based on intercalation/insertion-type electrodes or conversion-type electrodes.

13. The electrolyte material of claim 11, wherein the batteries include negative electrode chemistry based on intercalation/insertion-type electrodes, conversion-type electrodes, alloying-type electrodes, metal-type electrodes, or guest-host-type electrodes.

14. A method of obtaining fluorinated acetal molecules, comprising a chemical reaction among one or more fluorinated alcohols, one or more bases, and a dihalomethane.

15. A method of obtaining fluorinated acetal molecules, comprising a chemical reaction among one or more fluorinated alcohols, formaldehyde, and one or more acids or bases.

16. A method of obtaining fluorinated acetal molecules, comprising a chemical reaction among one or more fluorinated alcohols, paraformaldehyde, and one or more acids or bases.

17. A method of obtaining a fluorinated acetal, comprising:
preparing a suspension including 2-fluoroethanol, dibromomethane, NaOH and tetraglyme;
stirring the suspension at room temperature;
heating the suspension; and
directly distilling the suspension under vacuum to obtain di-(2-fluoroethoxy)methane as the product.

18. A method of obtaining a fluorinated acetal, comprising:
preparing a suspension including 2-2-Difluoroethanol, dibromomethane, NaOH and tetraglyme;
stirring the suspension at room temperature;
heating the suspension; and
directly distilling the suspension under vacuum to obtain bis-(2,2-difluoroethoxy)methane as the product.

19. A method of obtaining an electrolyte, comprising:
combining a fluorinated acetal obtained with the method of claim 18 with a salt.

20. The method of claim 19, wherein the salt comprises bis(fluorosulfonyl)imide (LiFSI).

21. The method of claim 20, further comprising:
injecting the combination into a separator.

22. A battery comprising:
an electrolyte obtained by combining a fluorinated acetal obtained with the method of claim 17 with a salt.

23. A battery comprising:
an electrolyte obtained by combining a fluorinated acetal obtained with the method of claim 18 with a salt.

24. The battery of claim 23, wherein the salt comprises bis(fluorosulfonyl)imide (LiFSI).

25. The battery of claim 23, further comprising:
a lithium metal anode.

26. The battery of claim 23, further comprising:
a high voltage cathode.
